(19) United States
(12) Patent Application Publication
(10) Pub. No.: US 2024/0340786 A1
(43) Pub. Date: Oct. 10, 2024

(54) Method And Apparatus For Network Energy Saving In Spatial And Power Domains

(71) Applicant: MediaTek Inc., Hsinchu City (TW)

(72) Inventors: Wei-De Wu, Hsinchu City (TW); Chi-Hsuan Hsieh, Hsinchu City (TW)

(21) Appl. No.: 18/621,094

(22) Filed: Mar. 29, 2024

Related U.S. Application Data
(60) Provisional application No. 63/457,855, filed on Apr. 7, 2023.
(60) Provisional application No. 63/466,395, filed on May 15, 2023.

(51) Int. Cl. H04W 52/02

(52) U.S. Cl. CPC H04W 52/0203

(57) ABSTRACT

Examples pertaining to network energy saving in spatial and power domains in mobile communications are described. A user equipment (UE) receives a report configuration from a network node having a plurality of antenna ports and transmits a measurement report based on the report configuration. The report configuration comprises information regarding at least one adaptation pattern associated with a measurement resource configuration and indicating at least one of a target number of the antenna ports and a power offset value configured by the network node.

### CROSS REFERENCE TO RELATED PATENT APPLICATION(S)

The present disclosure is part of a non-provisional application claiming the priority benefit of U.S. Patent Application No. 63/457,855, filed 7 Apr. 2023 and U.S. Patent Application No. 63/466,395, filed 15 May 2023, the contents of which herein being incorporated by reference in their entirety.

### TECHNICAL FIELD

The present disclosure is generally related to mobile communications and, more particularly, to network energy saving techniques in at least one of a spatial domain and a power domain with respect to a user equipment (UE) and a network node in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network. Therefore, it is important to achieve 5G network power savings. There are many conflicts among performance metrics. For example, quality of service (QOS), which may be affected by channel assessment accuracy, and power savings may need a tradeoff.

Considering of this, how to achieve network power saving while maintaining accurate channel state information (CSI) feedback evaluation at the UE side becomes an important issue for the newly developed wireless communication network. Therefore, there is a need to provide proper schemes for configurations in network power saving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to configurations for network energy saving techniques in at least one of a spatial domain and a power domain with respect to a communication apparatus (e.g., a UE) and a network apparatus (e.g., a network node or a base station (BS), such as a next generation Node B (gNB)) in mobile communications.

In one aspect, a method may involve an apparatus (e.g., a communication apparatus) receiving a report configuration from a network node having a plurality of antenna ports and transmitting a measurement report based on the report configuration. The report configuration comprises information regarding at least one adaptation pattern associated with a measurement resource configuration, and the adaptation pattern indicates at least one of a target number of the antenna ports and a power offset value configured by the network node.

In one aspect, a method may involve an apparatus (e.g., a network apparatus) configuring at least one adaptation pattern associated with a measurement resource configuration and transmitting a report configuration comprising information regarding the adaptation pattern to a communication apparatus for channel state information (CSI) evaluation. The adaptation pattern indicates at least one of a target number of a plurality of antenna ports and a power offset value.

In one aspect, a method may involve an apparatus (e.g., a network apparatus) configuring a cell-wise indication of an adaptation and transmitting the cell-wise indication to one or more communication apparatuses in a communication network. The cell-wise indication comprises information regarding at least one of a number of antenna ports enabled for channel state information (CSI) evaluation, a change in a power offset value and a reset of a predetermined procedure.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of type 1 SD adaptation under schemes in accordance with implementations of the present disclosure.

FIG. 2 is a diagram depicting an example scenario of type 2 SD adaptation under schemes in accordance with implementations of the present disclosure.

FIG. 3 is a diagram depicting an example scenario of different power offsets under schemes in accordance with implementations of the present disclosure.

FIG. 4 is a diagram depicting an example communication system having an example communication apparatus and an example network apparatus in accordance with an implementation of the present disclosure.

FIG. 5 is a diagram depicting an example process in accordance with an implementation of the present disclosure.

FIG. 6 is a diagram depicting another example process in accordance with an implementation of the present disclosure.

FIG. 7 is a diagram depicting yet another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to configurations associated with an adaptation in at least one of a spatial domain and a power domain for network energy saving. According to the present disclosure, a number of possible solutions may be implemented separately or jointly. That is, although these possible solutions may be described below separately, two or more of these possible solutions may be implemented in one combination or another.

The 5G New Radio (NR) may support a network node to have an antenna architecture with a plurality of physical antennas (or antenna elements) which associates with a plurality of antenna ports. The network node may perform adaptation in a spatial domain or in a power domain to achieve network energy saving. The spatial domain (SD) adaptation may be implemented by muting or unmuting one or more physical antennas or one or more antenna ports, or, enabling or disabling one or more physical antennas or one or more antenna ports in a dynamic or semi-static manner. The power domain (PD) adaptation may be implemented by adjusting downlink power to reduce power consumption.

Regarding the spatial adaptation pattern configuration, there may be two types of adaptations, including a type 1 SD adaptation and a type 2 SD adaptation.

For the type 1 SD adaptation, all physical antennas associated with a logical antenna port may be either disabled (muted) or enabled (unmuted), based on the specific network configuration or energy-saving requirements. When all physical antennas are enabled, the network provides a full radio coverage, while disabling some physical antennas reduces energy consumption. This adaptation may be particularly beneficial when demand is low, and the network may afford to disable some of its transmission ports to preserve energy.

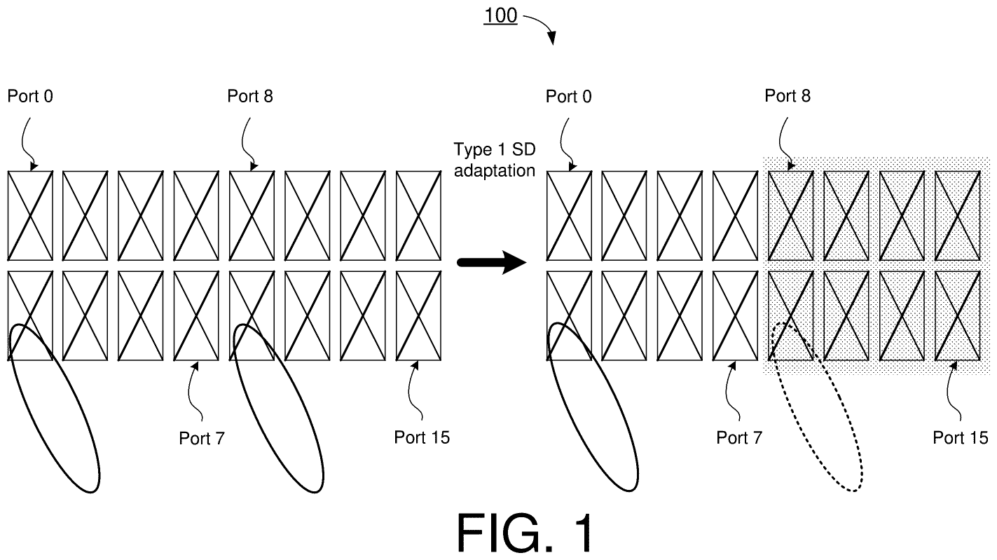

FIG. 1 illustrates an example scenario 100 of type 1 SD adaptation under schemes in accordance with implementations of the present disclosure. In FIG. 1, an example of type 1 spatial adaptation pattern, which may also be regarded as an antenna port subset, is shown, where one rectangle may represent one antenna port.

In the spatial adaptation pattern shown in FIG. 1, the antenna ports 8-15 are disabled (muted) by a network node or a network apparatus. In this embodiment, the status of the antenna ports 0-7 are enabled, and the status of the antenna ports 8-15 are changed from an enabled status to a disabled status after the SD adaptation is applied for implementing network energy saving in spatial domain.

Note that in other implementations, one diagonal (or one slash) drawn in a rectangle may represent one antenna port. Therefore, in such implementations, there may be 32 antenna ports drawn in FIG. 1. The rectangle comprising antenna port 0 may further comprise another antenna port 16. The rectangle comprising antenna port 7 may further comprise another antenna port 23. The rectangle comprising antenna port 8 may further comprise another antenna port 24. The rectangle comprising antenna port 15 may further comprise another antenna port 31, and the rest may be deduced by analogy. In addition, in such implementations, the antenna ports 8-15 and 24-31 may be disabled (muted) by the network apparatus after the SD adaptation is applied.

For the type 2 SD adaptation, disabling or enabling of a part or a subset of physical antennas associated with a logical antenna port (e.g., a logical channel state information-reference signal (CSI-RS) antenna port) is involved. Note that one antenna port may correspond to one CSI-RS. This approach provides finer granularity in controlling spatial domain adaptation, allowing a more tailored trade-off between energy efficiency and radio performance. Type 2 SD adaptation may help maintain user experience and network performance while optimizing energy consumption based on network conditions and user demand. One major difference with Type 2 adaptation is that both the network apparatus and the communication apparatus (e.g., a UE) deal with a constant number of CSI-RS ports, thus eliminating the varying CSI evaluation limitation along the NES adaptation.

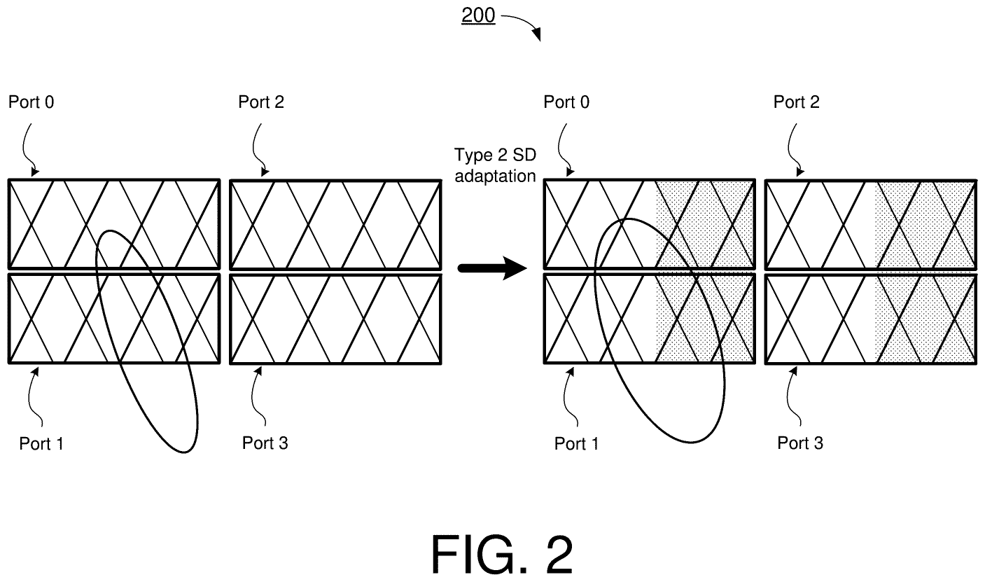

FIG. 2 illustrates an example scenario 200 of type 2 SD adaptation under schemes in accordance with implementations of the present disclosure. In FIG. 2, an example of type 2 spatial adaptation pattern is shown, where one rectangle may represent one antenna port and one slash may represent one physical antenna in the corresponding antenna port.

In this embodiment, after the SD adaptation is applied for implementing network energy saving in spatial domain, half of the physical antennas in each antenna port are enabled and the other half of the physical antennas in each antenna port are changed from an enabled status to a disabled status.

Note that in other implementations with the architecture shown in FIG. 2, the number of physical antennas comprised in one antenna port may be halved. As an example, the four parallel slashes extending along the same direction in one rectangle may represent the four physical antennas of one antenna port. Therefore, in such implementations, there may be 8 antenna ports shown in FIG. 2 and each rectangle may correspond to 2 antenna ports. For example, the antenna port 0 may comprise four physical antennas represented by four parallel slashes extending along a first direction in the corresponding rectangle, and the rectangle comprising the antenna port 0 may further comprise another antenna port 4 having four physical antennas represented by the other four parallel slashes extending along a second direction. Similarly, the antenna port 1 may comprise four physical antennas represented by four parallel slashes extending along a first direction in the corresponding rectangle, and the rectangle comprising the antenna port 1 may further comprise another antenna port 5 having four physical antennas represented by the other four parallel slashes extending along a second direction. The rest may be deduced by analogy.

In addition, in such implementations, half of the physical antennas in each antenna port are enabled and the other half of the physical antennas in each antenna port are changed from an enabled status to a disabled status after the SD adaptation is applied.

In some implementations, the network apparatus may adjust one or more downlink powers to implement power domain (PD) adaptation, and when the downlink power is reduced, power consumption in network apparatus is reduced as well.

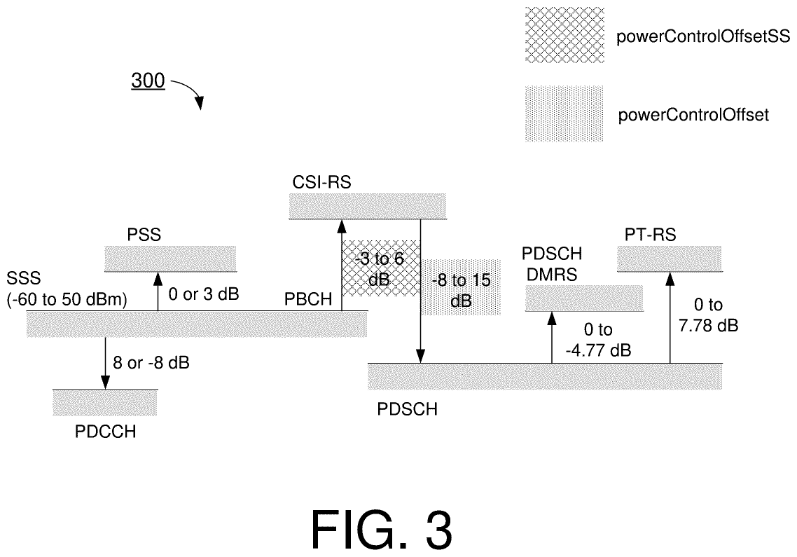

FIG. 3 illustrates an example scenario 300 of different power offsets under schemes in accordance with implementations of the present disclosure. Scenario 300 involves a network apparatus and a communication apparatus (e.g., a UE), which may be a part of a wireless communication network (e.g., an LTE network, a 5G/NR network, an IoT network or a 6G network). The network apparatus may determine the downlink transmit power, e.g., the energy per resource element (EPRE), for the UE. The network apparatus may first indicate the downlink transmit power of synchronization signal (SS) and physical broadcast channel (PBCH) block (i.e., SSB) in a master information block (MIB) or a system information block (SIB).

The UE may derive the downlink CSI-RS EPRE from the SS/PBCH block downlink transmit power and CSI-RS power offset given by the parameter powerControlOffsetSS provided by higher layers. Referring to FIG. 3, the parameter powerContolOffsetSS may indicate a value in the range of [−3, 6] dB. The parameter powerContolOffset is the assumed ratio of physical downlink shared channel (PDSCH) EPRE to non-zero power (NZP) CSI-RS EPRE when UE derives CSI feedback and may indicate a value in the range of [−8, 15] dB.

To enhance network efficiency with minimum design changes and optimizations, there are two topics provided in the following for discussion, including: adaptation pattern configuration and indication of spatial and power domain adaptation.

In some implementations, the network node or network apparatus may perform an adaptation in at least one of the spatial domain and the power domain to achieve network energy saving. More specific, the network apparatus may solely perform the aforementioned type 1 SD adaptation or type 2 SD adaptation, or may solely perform the aforementioned PD adaptation to achieve network energy saving. In addition, the network apparatus may perform both adaptation in both spatial domain (either the type 1 SD adaptation or the type 2 SD adaptation) and power domain.

It is noticed that, in some implementations, the type 2 SD adaptation may be intentionally merged with PD adaptation in order to achieve a unified network energy saving (NES) adaptation framework so as to minimize the required UE changes.

To improve adaptation in either spatial domain or power domain, it is essential to associate CSI-RS resources, resource sets, and resource settings with adaptation patterns efficiently. This may be achieved by introducing flexible configuration schemes that enable each CSI-RS resource, resource set, or resource setting to be associated with one or multiple adaptation patterns. This flexibility in configuration improves the network's ability to adapt to various spatial or power domain scenarios, enhancing energy efficiency and user experience.

In some implementations, a step toward improving CSI-RS configuration for an adaptation (e.g., a spatial or power domain adaptation) is defining one or more adaptation patterns (e.g., spatial adaptation patterns) and the associated augmented configurations.

In some implementations, when the network apparatus performs an adaptation, the network apparatus may configure at least one adaptation pattern associated with a measurement resource configuration and transmit a report configuration comprising information regarding the adaptation pattern to the communication apparatus for CSI evaluation.

Note that in some implementations, there may be multiple adaptation patterns (e.g., spatial adaptation patterns) associated with a measurement resource configuration, such as an NZP-CSI-RS resource configuration.

In some implementations, the adaptation pattern may be an augmented configuration based on a measurement resource configuration, such as an NZP-CSI-RS resource configuration, and may indicate or may comprise information regarding at least one of a target number of a plurality of antenna ports (e.g., the parameter ‘nrofPorts’ indicating the number of antenna ports) and a power offset value.

In some implementations, the power offset value may comprise an offset or a change of at least one of a power offset for a PDSCH relative to a CSI-RS (e.g., the aforementioned parameter ‘powerContolOffset’) and a power offset for a CSI-RS relative to a secondary synchronization signal (SSS) (e.g., the aforementioned parameter ‘powerContolOffsetSS’). In some implementations, the power offset value may indicate a difference to the power offset for the PDSCH relative to the CSI-RS (e.g., the aforementioned parameter ‘powerContolOffset’). In some implementations, the power offset value may indicate a difference to the power offset for the CSI-RS relative to the SSS (e.g., the aforementioned parameter ‘powerContolOffsetSS’). In some implementations, the power offset value may be used to determine at least one candidate power offset value of the ‘powerControlOffset’ or the ‘powerControlOffsetSS’. For example, the power offset value may be an offset value relative to the ‘powerControlOffset’ or the ‘powerControlOffsetSS’.

In some implementations, the adaptation pattern may further comprise or indicate a subset selection of the antenna ports (e.g., an antenna port subset or a CSI-RS antenna port subset) and a specified codebook configuration.

In some implementations, the adaptation pattern may further comprise or indicate at least one of a resource identity, such as the resource identity of the associated measurement resource.

In some implementations, the specified codebook configuration may comprise an indication of at least one of a codebook subset restriction, a rank restriction, a number of antenna ports in a first dimension (e.g., the parameter N1) and a number of antenna ports in a second dimension (e.g., the parameter N2) (e.g., in an event that a single-panel codebook is configured) and/or a codebook subset restriction for the single-panel codebook (e.g., the parameter n1-n2), a number of panels (e.g., the parameter Ng) (e.g., in an event that a multi-panel codebook is configured) and/or a codebook subset restriction for the multi-panel codebook (e.g., the parameter ng-n1-n2) and a codebook subset restriction for two-transmission (two-TX) (e.g., the parameter twoTX-CodebookSubsetRestriction). The codebook subset restriction (e.g., the parameters n1-n2, ng-n1-n2 and twoTX-CodebookSubsetRestriction) may be a bitmap parameter, and the bitmap parameter may form a bit sequence, where a bit value of zero indicates that precoding matrix indicator (PMI) reporting is not allowed to correspond to any precoder associated with the bit.

In some implementations, an adaptation pattern or a spatial adaptation pattern may be defined based on an NZP-CSI-RS resource configuration that includes the associated NZP-CSI-RS-ResourceId, a target value or a target number of antenna ports of ‘nrofPorts’, explicit subset selection of antenna ports, a specified codebook configuration, and a list of candidate power offset values of ‘powerControlOffset’ or ‘powerControlOffsetSS’.

Note that for Type 2 SD adaptation, which involves selectively disabling or enabling of one or more physical antennas, the CSI evaluation may approximate this behavior as adjusting the power offset value of a given CSI-RS resource configuration. This approximation assumes that using the same rank indicator (RI) and PMI for Type 2 SD adaptation is feasible, with limited degradation in network performance.

In some implementations, an adaptation pattern or a spatial adaptation pattern may be a list of sub-configurations or may comprise a list of sub-configurations, the list of sub-configurations may comprise one or more sub-configurations and each sub-configuration may correspond to an antenna port subset. As an example, for the type 1 SD adaptation, each sub-configuration may correspond to an antenna port subset.

In some implementations, an adaptation pattern or a spatial adaptation pattern may be a list of sub-configurations or may comprise a list of sub-configurations, the list of sub-configurations may comprise one or more sub-configurations and each sub-configuration may correspond to a list of measurement resources. As an example, for the type 2 SD adaptation, each sub-configuration may correspond to a list of measurement resources.

Note that in some implementations, one measurement report (e.g., CSI report) configuration may comprise multiple sub-configurations, and each sub-configuration may correspond to one adaptation pattern.

In some implementations, in an event that a sub-configuration corresponds to an antenna port subset, the network apparatus may determine an enabled or disabled status of the antenna ports for the corresponding antenna port subset and transmit one or more CSI-RS associated with the antenna port subset. Note that one or more disabled antenna ports in the antenna port subset may be not involved in the transmitting of the associated CSI-RS.

In some implementations, in an event that a sub-configuration corresponds to an antenna port subset, the sub-configuration comprises a bitmap parameter, and the target number of the antenna ports (e.g., the parameter ‘nrofPorts’) may be indicated by the bitmap parameter.

In some implementations, the bitmap parameter may comprise a bit sequence, each bit in the bit sequence corresponds to at least one antenna port, and a predefined bit value of the bit indicates that the corresponding antenna port is disabled (or enabled) for the corresponding sub-configuration. In some implementations, the target number of the antenna ports may be explicitly indicated by the number of bits comprised in the bit sequence with its bit value being set to the predefined bit value (e.g., ‘0’ or ‘1’).

In some implementations, an adaptation pattern or a spatial adaptation pattern may be an augmented configuration based on an NZP-CSI-RS resource configuration, such a list of sub-configurations csi-ReportSubConfigList of an NZP-CSI-RS resource configuration, and a sub-configuration within a CSI report configuration may comprise the following parameters:
(0) Sub-configuration ID (e.g., the parameter csi-ReportSubConfigID),
(1) either 1a) or 1b) as follows:
   1a):
      codebook subset restriction,
      rank restriction,
      N1, N2 if single-panel codebook is configured and additionally Ng if multi-panel codebook configured,
      twoTX-CodebookSubsetRestriction,
      CSI-RS antenna port subset indication by bitmap (e.g., the parameter port-subsetIndicator);
   1b): a list of nzp-CSI-RS-resources corresponding to the associated resources in the CSI resource set (e.g., the parameter nzp-CSI-RS-resourceList); and
(2) a power offset value (e.g., an offset of the aforementioned power offset parameter ‘powerContolOffset’ or ‘powerContolOffsetSS’).

Note that a sub-configuration always contains at least one of (1) and (2).

In some implementations, with the adaptation pattern (or spatial adaptation pattern) as described above, indication of the adaptation patterns may be utilized to provide the restriction information for the CSI evaluation in UE, which implies a sub-configuration of CSI report may simply refer to the setting of the adaptation pattern. Additionally, indication of an active adaptation pattern may also provide the restriction information in an efficient manner.

In some implementations, the configuration of adaptation patterns or spatial adaptation patterns may be utilized for CSI report as well as indication of spatial and power domain adaptation for efficient provision of restriction information for UE CSI measurement and evaluation.

With respect to the communication apparatus (e.g., the UE), in some implementations, the communication apparatus may receive a report configuration from a network node having a plurality of antenna ports and transmit a measurement report based on the report configuration. In some implementations, the report configuration may comprise information regarding at least one adaptation pattern associated with a measurement resource configuration, and the adaptation pattern may indicate at least one of a target number of the antenna ports and a power offset value configured by the network node.

In some implementations, the adaptation pattern may be an augmented configuration based on the measurement resource configuration, such as an NZP-CSI-RS resource configuration, and may indicate or may comprise information regarding at least one of a target number of a plurality of antenna ports (e.g., the parameter ‘nrofPorts’) and a power offset value.

In some implementations, the power offset value may comprise an offset or a change of at least one of a power offset for a PDSCH relative to a CSI-RS (e.g., the aforementioned parameter ‘powerContolOffset’) and a power offset for a CSI-RS relative to an SSS (e.g., the aforementioned parameter ‘powerContolOffsetSS’). In some implementations, the power offset value may indicate a difference to the power offset for the PDSCH relative to the CSI-RS (e.g., the aforementioned parameter ‘powerContolOffset’). In some implementations, the power offset value may indicate a difference to the power offset for the CSI-RS relative to the SSS (e.g., the aforementioned parameter ‘powerContolOffsetSS’). In some implementations, the power offset value may be used to determine at least one candidate power offset value of the ‘powerControlOffset’ or the ‘powerControlOffsetSS’.

In some implementations, the adaptation pattern may further comprise or indicate a subset selection of the antenna ports (e.g., an antenna port subset or a CSI-RS antenna port subset) and a specified codebook configuration.

In some implementations, the adaptation pattern may further comprise or indicate at least one of a resource identity, such as the resource identity of the associated measurement resource.

In some implementations, the specified codebook configuration may comprise an indication of at least one of a codebook subset restriction, a rank restriction, a number of antennas ports in a first dimension (e.g., the parameter N1) and a number of antenna ports in a second dimension (e.g., the parameter N2) (e.g., in an event that a single-panel codebook is configured) and/or a codebook subset restriction for the single-panel codebook (e.g., the parameter n1-n2), a number of panels (e.g., the parameter Ng) (e.g., in an event that a multi-panel codebook is configured) and/or a codebook subset restriction for the multi-panel codebook (e.g., the parameter ng-n1-n2) and a codebook subset restriction for two-transmission (two-TX). The codebook subset restriction (e.g., the parameters n1-n2, ng-n1-n2 and twoTX-CodebookSubsetRestriction) may be a bitmap parameter, and the bitmap parameter may form a bit sequence, where a bit value of zero indicates that precoding matrix indicator (PMI) reporting is not allowed to correspond to any precoder associated with the bit.

In some implementations, an adaptation pattern or a spatial adaptation pattern may be a list of sub-configurations or may comprise a list of sub-configurations, the list of sub-configurations may comprise one or more sub-configurations and each sub-configuration may correspond to or an antenna port subset. As an example, for the type 1 SD adaptation, each sub-configuration may correspond to an antenna port subset.

In some implementations, an adaptation pattern or a spatial adaptation pattern may be a list of sub-configurations or may comprise a list of sub-configurations, the list of sub-configurations may comprise one or more sub-configurations and each sub-configuration may correspond to a list of measurement resources. As an example, for the type 2 SD adaptation, each sub-configuration may correspond to a list of measurement resources.

In some implementations, in an event that a sub-configuration corresponds to an antenna port subset, the communication apparatus may measure the CSI-RS based on the report configuration and generate the measurement report according to a result of the measuring of the CSI-RS and the specified codebook configuration. In some implementations, the antenna port subset corresponding to the sub-configuration indicates one or more enabled or disabled antenna ports, and the measuring of the CSI-RS associated with one or more disabled antenna ports may be not performed by the communication apparatus.

In some implementations, in an event that a sub-configuration corresponds to an antenna port subset, the sub-configuration may comprise a bitmap parameter, and the target number of the antenna ports (e.g., the parameter ‘nrofPorts’) may be indicated by the bitmap parameter.

In some implementations, the bitmap parameter may comprise a bit sequence, each bit in the bit sequence corresponds to at least one antenna port, and a predefined bit value of the bit indicates that the corresponding antenna port is disabled (or enabled) for the corresponding sub-configuration. For example, the target number of the antenna ports may be explicitly indicated by the number of bits comprised in the bit sequence with its bit value being set to the predefined bit value (e.g., ‘0’ or ‘1’).

Note that the PD adaptation for NES may also be evaluated along the CSI report for an adaptation pattern with multiple candidate power offset values of ‘powerControlOffset’ or ‘powerControlOffsetSS’. This enhancement enables the network apparatus to further optimize the power allocation of the NZP-CSI-RS resource based on the evaluation feedback from the communication apparatus. The communication apparatus may report the CSI for each candidate power offset value of ‘powerControlOffset’ or ‘powerControlOffsetSS’ indicated in the adaptation pattern, and the network apparatus may select the most energy-efficient value that meets the quality of service requirements.

With the measurement report (e.g., the CSI report), the network apparatus may decide which CSI-RS port(s) (or antenna port(s)) to disable or enable (Type 1 SD adaptation), which physical antennas from each CSI-RS port (or antenna port) to disable or enable (Type 2 SD adaptation) and/or the most energy-efficient power offset value(s). Taking these reports into account may facilitate the network apparatus to optimize its resources, adapt to different network scenarios, and reduce energy consumption while providing a satisfactory user experience.

In some implementations, when the network apparatus makes decisions based on CSI reports provided by the communication apparatus, indications of the selected CSI-RS ports (selected subset of antenna ports) (for Type 1 SD adaptation) and corresponding power offset value(s) (for Type 2 SD adaptation or power domain adaptation) are preferably provided to the communication apparatus. These indications may allow the communication apparatus to adjust its measurements and CSI calculations accordingly to stay aligned with the network's energy-saving goals.

For example, if the network apparatus disables a specific CSI-RS port or adjusts the power offset of a physical antenna, the communication apparatus must be aware of these changes. By explicitly providing the communication apparatus the result of antenna port subset selection or power change, the network apparatus prevents the communication apparatus from ill or dummy CSI calculations and contributes to more accurate channel state information. By explicitly providing the communication apparatus with the power offset for CSI-RS after the adaptation, the network apparatus may ensure that the communication apparatus is able to compensate the power offset difference in performing channel average and thus improve CSI accuracy.

In some implementations, the network apparatus may configure a cell-wise indication of an adaptation and transmit the cell-wise indication to one or more communication apparatuses in a communication network. The cell-wise indication may comprise information regarding at least one of a number of antenna ports enabled for CSI evaluation (or a change in the number of enabled antenna ports), a number of physical antennas enabled for CSI evaluation (or a change in the number of enabled antennas), a change in a power offset value and a reset (or partial reset) of a predetermined procedure.

In some implementations, the predetermined procedure may comprise at least one of a CSI evaluation procedure and a beam management procedure, and the adaptation may comprise at least one of a spatial domain adaptation and a power domain adaptation.

In some implementations, the cell-wise indication may be transmitted via a group-specific downlink control information (DCI) or by a paging DCI. In some implementations, the cell-wise indication may be implemented by using, defining or involving a new group-specific DCI format. In some implementations, the cell-wise indication may be implemented by extending paging DCI format(s), such as DCI format 1_0 with paging radio network temporary Identity (P-RNTI) or DCI format 2_7 with paging early indication (PEI) RNTI (PEI-RNTI).

In some implementations, the power offset value may comprise at least one of a power offset for a PDSCH relative to a CSI-RS (e.g., the aforementioned parameter ‘powerContolOffset’) and a power offset for a CSI-RS relative to an SSS (e.g., the aforementioned parameter ‘powerContolOffsetSS’).

In some implementations, to minimize energy overhead when sending indications to communication apparatuses (e.g., UEs), one approach may involve using UE-group-wise indications, where these indications may be sent to a specific group of UEs simultaneously, rather than individually signaling each UE. This approach reduces signaling overhead and results in significant energy savings for the network.

In some implementations, the UE-group-wise indication may be facilitated by using a new group-specific DCI format or by reusing the paging indication DCI.

### Illustrative Implementations

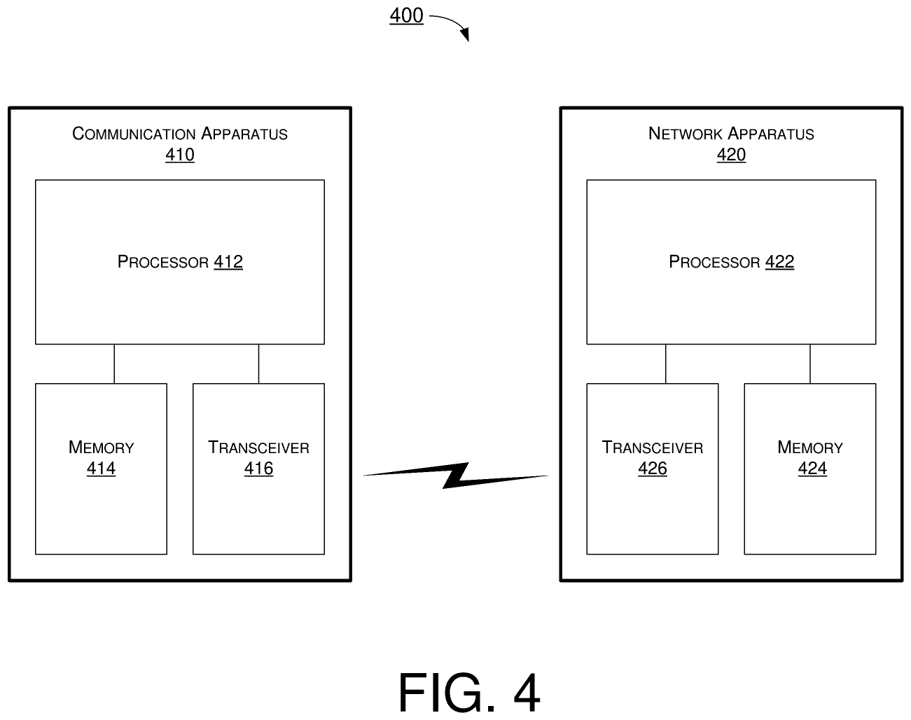

FIG. 4 illustrates an example communication system 400 having an example communication apparatus 410 and an example network apparatus 420 in accordance with an implementation of the present disclosure. Each of the communication apparatus 410 and the network apparatus 420 may perform various functions to implement schemes, techniques, processes and methods described herein pertaining to configurations for network energy saving techniques in at least one of a spatial domain and a power domain with respect to user equipment and network apparatus in mobile communications, including scenarios/schemes described above as well as the process 500, the process 600 and the process 700 described below.

The communication apparatus 410 may be a part of an electronic apparatus, which may be a UE such as a portable or mobile apparatus, a wearable apparatus, a wireless communication apparatus or a computing apparatus. For instance, the communication apparatus 410 may be implemented in a smartphone, a smartwatch, a personal digital assistant, a digital camera, or a computing equipment such as a tablet computer, a laptop computer or a notebook computer. The communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 410 may be implemented in a smart thermostat, a smart fridge, a smart door lock, a wireless speaker or a home control center. Alternatively, the communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 410 may include at least some of those components shown in FIG. 4 such as a processor 412, for example. The communication apparatus 410 may further include one or more other components not pertinent to the proposed scheme of the present disclosure (e.g., internal power supply, display device and/or user interface device), and, thus, such component(s) of the communication apparatus 410 are neither shown in FIG. 4 nor described below in the interest of simplicity and brevity.

The network apparatus 420 may be a part of a network device, which may be a network node such as a satellite, a base station, a small cell, a router or a gateway. For instance, the network apparatus 420 may be implemented in an eNodeB in an LTE network, in a gNB in a 5G/NR, IoT, NB-IoT or IIoT network or in a satellite or base station in a 6G network. Alternatively, the network apparatus 420 may be implemented in the form of one or more IC chips such as, for example and without limitation, one or more single-core processors, one or more multi-core processors, or one or more RISC or CISC processors. The network apparatus 420 may include at least some of those components shown in FIG. 4 such as a processor 422, for example. The network apparatus 420 may further include one or more other components not pertinent to the proposed scheme of the present disclosure (e.g., internal power supply, display device and/or user interface device), and, thus, such component(s) of the network apparatus 420 are neither shown in FIG. 4 nor described below in the interest of simplicity and brevity.

In one aspect, each of the processor 412 and the processor 422 may be implemented in the form of one or more single-core processors, one or more multi-core processors, or one or more CISC processors. That is, even though a singular term “a processor” is used herein to refer to the processor 412 and the processor 422, each of the processor 412 and the processor 422 may include multiple processors in some implementations and a single processor in other implementations in accordance with the present disclosure. In another aspect, each of the processor 412 and the processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and the processor 422 is a special-purpose machine specifically designed, arranged and configured to perform specific tasks including autonomous reliability enhancements in a device (e.g., as represented by the communication apparatus 410) and a network (e.g., as represented by the network apparatus 420) in accordance with various implementations of the present disclosure.

In some implementations, the communication apparatus 410 may also include a transceiver 416 coupled to the processor 412 and capable of wirelessly transmitting and receiving data. In some implementations, the communication apparatus 410 may further include a memory 414 coupled to the processor 412 and capable of being accessed by the processor 412 and storing data therein. In some implementations, the network apparatus 420 may also include a transceiver 426 coupled to the processor 422 and capable of wirelessly transmitting and receiving data. In some implementations, the network apparatus 420 may have a plurality of physical antennas which associates with a plurality of antenna ports. In some implementations, the network apparatus 420 may further include a memory 424 coupled to processor 422 and capable of being accessed by the processor 422 and storing data therein. Accordingly, the communication apparatus 410 and the network apparatus 420 may wirelessly communicate with each other via the transceiver 416 and the transceiver 426, respectively. To aid better understanding, the following description of the operations, functionalities and capabilities of each of the communication apparatus 410 and the network apparatus 420 is provided in the context of a mobile communication environment in which the communication apparatus 410 is implemented in or as a communication apparatus or a UE and the network apparatus 420 is implemented in or as a network node or a network device of a communication network.

In some implementations, the processor 412 of the communication apparatus 410 may receive, via the transceiver 416, a report configuration from a network node (e.g., the network apparatus 420) having a plurality of antenna ports and transmit a measurement report based on the report configuration. The report configuration may comprise information regarding at least one adaptation pattern associated with a measurement resource configuration and the adaptation pattern may indicate at least one of a target number of the antenna ports and a power offset value configured by the network node.

In some implementations, the adaptation pattern may further indicate at least one of a subset selection of the antenna ports and a specified codebook configuration.

In some implementations, the specified codebook configuration may comprise an indication of at least one of a codebook subset restriction, a rank restriction, a number of antenna ports in a first dimension and a number of antenna ports in a second dimension, a codebook subset restriction for a single-panel codebook, a number of panels, a codebook subset restriction for a multi-panel codebook and a codebook subset restriction for two-transmission (two-TX).

In some implementations, the power offset value may be used to determine at least one candidate power offset value.

In some implementations, the adaptation pattern may comprise a list of sub-configurations, and each sub-configuration may correspond to an antenna port subset.

In some implementations, the processor 412 may measure a CSI-RS based on the report configuration and generate the measurement report according to a result of the measuring of the CSI-RS and the specified codebook configuration. The antenna port subset corresponding to a sub-configuration may indicate one or more enabled or disabled antenna ports.

In some implementations, in an event that a sub-configuration corresponds to an antenna port subset, the sub-configuration may comprise a bitmap parameter, and the target number of the antenna ports may be indicated by the bitmap parameter.

In some implementations, the bitmap parameter may comprise a bit sequence, each bit in the bit sequence may correspond to at least one antenna port, and a predefined bit value of the bit may indicate that the corresponding antenna port is disabled or enabled for the corresponding sub-configuration.

In some implementations, the adaptation pattern may further indicate a resource identity.

In some implementations, the adaptation pattern may comprise a list of sub-configurations, and each sub-configuration may correspond to a list of measurement resources.

In some implementations, the processor 422 of the network apparatus 420 may configure at least one adaptation pattern associated with a measurement resource configuration and transmit, via the transceiver 426, a report configuration comprising information regarding the adaptation pattern to a communication apparatus (e.g., the communication apparatus 410) for CSI evaluation. The adaptation pattern may indicate at least one of a target number of a plurality of antenna ports and a power offset value.

In some implementations, the adaptation pattern may further indicate at least one of a subset selection of the antenna ports and a specified codebook configuration.

In some implementations, the specified codebook configuration may comprise an indication of at least one of a codebook subset restriction, a rank restriction, a number of antenna ports in a first dimension and a number of antenna ports in a second dimension, a number of panels, a codebook subset restriction for a multi-panel codebook and a codebook subset restriction for two-transmission (two-TX).

In some implementations, the power offset value may be used to determine at least one candidate power offset value.

In some implementations, the adaptation pattern may comprise a list of sub-configurations, and each sub-configuration may correspond to an antenna port subset.

In some implementations, in an event that a sub-configuration corresponds to an antenna port subset, the processor 422 may further determine an enabled or disabled status of the antenna ports for the antenna port subset and transmit, via the transceiver 426, one or more CSI-RSs associated with the antenna port subset. One or more disabled antenna ports in the antenna port subset may be not involved in the transmitting of the associated CSI-RS.

In some implementations, the sub-configuration may comprise a bitmap parameter, and the target number of the antenna ports may be indicated by the bitmap parameter.

In some implementations, the bitmap parameter may comprise a bit sequence, each bit in the bit sequence may correspond to at least one antenna port, and a predefined bit value of the bit may indicate that the corresponding antenna port is disabled or enabled for the corresponding sub-configuration.

In some implementations, the adaptation pattern may further indicate a resource identity.

In some implementations, the adaptation pattern may comprise a list of sub-configurations, and each sub-configuration may correspond to a list of measurement resources.

In some implementations, the processor 422 may configure a cell-wise indication of an adaptation and transmit, via the transceiver 426, the cell-wise indication to one or more communication apparatuses in a communication network. The cell-wise indication may comprise information regarding at least one of a number of antenna ports enabled for CSI evaluation, a change in a power offset value and a reset of a predetermined procedure.

In some implementations, the predetermined procedure may comprise at least one of a CSI evaluation procedure and a beam management procedure, and the adaptation may comprise at least one of a spatial domain adaptation and a power domain adaptation.

In some implementations, the cell-wise indication may be transmitted via a group-specific DCI or by a paging DCI.

In some implementations, the power offset value may comprise at least one of a power offset for a PDSCH relative to a CSI-RS and a power offset for a CSI-RS relative to an SSS.

### Illustrative Processes

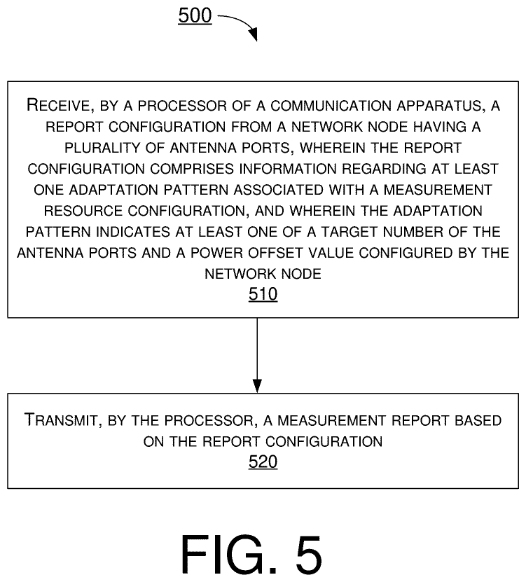

FIG. 5 illustrates an example process 500 in accordance with an implementation of the present disclosure. The process 500 may be an example implementation of above scenarios/schemes, whether partially or completely, with respect to configurations for network energy saving techniques in at least one of a spatial domain and a power domain in accordance with the present disclosure. The process 500 may represent an aspect of implementation of features of the communication apparatus 410. The process 500 may include one or more operations, actions, or functions as illustrated by one or more of blocks 510 and 520. Although illustrated as discrete blocks, various blocks of the process 500 may be divided into additional blocks, combined into fewer blocks, or eliminated, depending on the desired implementation. Moreover, the blocks of the process 500 may be executed in the order shown in FIG. 5 or, alternatively, in a different order. The process 500 may be implemented by the communication apparatus 410 or any suitable UE or machine type devices. Solely for illustrative purposes and without limitation, the process 500 is described below in the context of the communication apparatus 410. The process 500 may begin at block 510.

At 510, the process 500 may involve the processor 412 of the communication apparatus 410 receiving a report configuration from a network node having a plurality of antenna ports, such as the network apparatus 420. The report configuration may comprise information regarding at least one adaptation pattern associated with a measurement resource configuration, and the adaptation pattern may indicate at least one of a target number of the antenna ports and a power offset value configured by the network node. The process 500 may proceed from 510 to 520.

At 520, the process 500 may involve the processor 412 transmitting a measurement report based on the report configuration.

In some implementations, the adaptation pattern may further indicate at least one of a subset selection of the antenna ports and a specified codebook configuration.

In some implementations, the specified codebook configuration may comprise an indication of at least one of a codebook subset restriction, a rank restriction, a number of antenna ports in a first dimension and a number of antenna ports a second dimension, a codebook subset restriction for a single-panel codebook, a number of panels, a codebook subset restriction for a multi-panel codebook and a codebook subset restriction for two-transmission (two-TX).

In some implementations, the power offset value may be used to determine at least one candidate power offset value.

In some implementations, the adaptation pattern may comprise a list of sub-configurations, and each sub-configuration may correspond to an antenna port subset.

In some implementations, the process 500 may involve the processor 412 measuring a CSI-RS based on the report configuration and generating the measurement report according to a result of the measuring of the CSI-RS and the specified codebook configuration. The antenna port subset corresponding to a sub-configuration may indicate one or more enabled or disabled antenna ports.

In some implementations, in an event that a sub-configuration corresponds to an antenna port subset, the sub-configuration may comprise a bitmap parameter, and the target number of the antenna ports may be indicated by the bitmap parameter.

In some implementations, the bitmap parameter may comprise a bit sequence, each bit in the bit sequence may correspond to at least one antenna port, and a predefined bit value of the bit may indicate that the corresponding antenna port is disabled or enabled for the corresponding sub-configuration.

In some implementations, the adaptation pattern may further indicate a resource identity.

In some implementations, the adaptation pattern may comprise a list of sub-configurations, and each sub-configuration may correspond to a list of measurement resources.

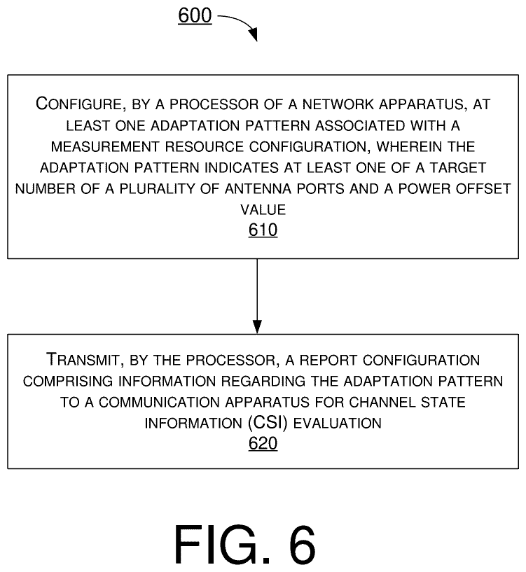

FIG. 6 illustrates an example process 600 in accordance with an implementation of the present disclosure. The process 600 may be an example implementation of above scenarios/schemes, whether partially or completely, with respect to configurations for network energy saving techniques in at least one of a spatial domain and a power domain in accordance with the present disclosure. The process 600 may represent an aspect of implementation of features of the network apparatus 420. The process 600 may include one or more operations, actions, or functions as illustrated by one or more of blocks 610 and 620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the network apparatus 420 or any suitable network node or machine type devices. Solely for illustrative purposes and without limitation, the process 600 is described below in the context of the network apparatus 420. The process 600 may begin at block 610.

At 610, the process 600 may involve the processor 422 of the network apparatus 420 configuring at least one adaptation pattern associated with a measurement resource configuration. The adaptation pattern may indicate at least one of a target number of a plurality of antenna ports and a power offset value. The process 600 may proceed from 610 to 620.

At 620, the process 600 may involve the processor 422 transmitting a report configuration comprising information regarding the adaptation pattern to a communication apparatus for CSI evaluation.

In some implementations, the adaptation pattern may further indicate at least one of a subset selection of the antenna ports and a specified codebook configuration.

In some implementations, the specified codebook configuration may comprise an indication of at least one of a codebook subset restriction, a rank restriction, a number of antenna ports in a first dimension and a number of antenna ports in a second dimension, a codebook subset restriction for a single-panel codebook, a number of panels, a codebook subset restriction for a multi-panel codebook and a codebook subset restriction for two-transmission (two-TX).

In some implementations, the power offset value may be used to determine at least one candidate power offset value.

In some implementations, the adaptation pattern may comprise a list of sub-configurations, and each sub-configuration may correspond to an antenna port subset.

In some implementations, in an event that a sub-configuration corresponds to an antenna port subset, the process 600 may involve the processor 422 determining an enabled or disabled status of the antenna ports for the antenna port subset and transmitting one or more CSI-RSs associated with the antenna port subset. One or more disabled antenna ports in the antenna port subset may be not involved in the transmitting of the associated CSI-RS.

In some implementations, the sub-configuration may comprise a bitmap parameter, and the target number of the antenna ports may be indicated by the bitmap parameter.

In some implementations, the bitmap parameter may comprise a bit sequence, each bit in the bit sequence may correspond to at least one antenna port, and a predefined bit value of the bit may indicate that the corresponding antenna port is disabled or enabled for the corresponding sub-configuration.

In some implementations, the adaptation pattern may further indicate a resource identity.

In some implementations, the adaptation pattern may comprise a list of sub-configurations, and each sub-configuration may correspond to a list of measurement resources.

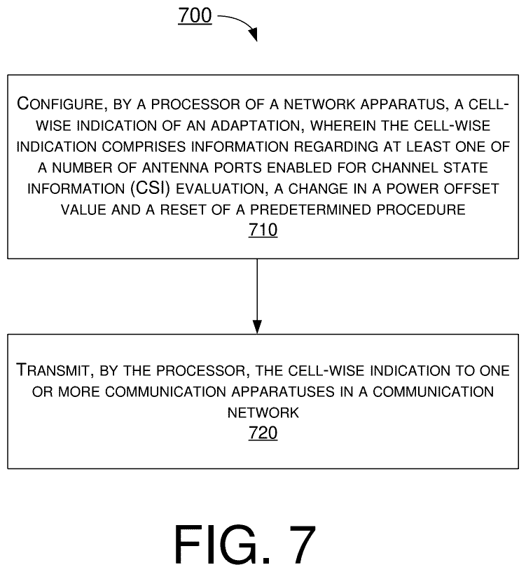

FIG. 7 illustrates an example process 700 in accordance with an implementation of the present disclosure. The process 700 may be an example implementation of above scenarios/schemes, whether partially or completely, with respect to configurations for network energy saving techniques in at least one of a spatial domain and a power domain in accordance with the present disclosure. The process 700 may represent an aspect of implementation of features of the network apparatus 420. The process 700 may include one or more operations, actions, or functions as illustrated by one or more of blocks 710 and 720. Although illustrated as discrete blocks, various blocks of the process 700 may be divided into additional blocks, combined into fewer blocks, or eliminated, depending on the desired implementation. Moreover, the blocks of the process 700 may be executed in the order shown in FIG. 7 or, alternatively, in a different order. The process 700 may be implemented by the network apparatus 420 or any suitable network node or machine type devices. Solely for illustrative purposes and without limitation, the process 700 is described below in the context of the network apparatus 420. The process 700 may begin at block 710.

At 710, the process 700 may involve the processor 422 of the network apparatus 420 configuring a cell-wise indication of an adaptation. The cell-wise indication may comprise information regarding at least one of a number of antenna ports enabled for CSI evaluation, a change in a power offset value and a reset of a predetermined procedure. The process 700 may proceed from 710 to 720.

At 720, the process 700 may involve the processor 422 transmitting the cell-wise indication to one or more communication apparatuses in a communication network.

In some implementations, the predetermined procedure may comprise at least one of a CSI evaluation procedure and a beam management procedure, and the adaptation may comprise at least one of a spatial domain adaptation and a power domain adaptation.

In some implementations, the cell-wise indication may be transmitted via a group-specific DCI or by a paging DCI.

In some implementations, the power offset value may comprise at least one of a power offset for a PDSCH relative to a CSI-RS and a power offset for a CSI-RS relative to an SSS.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a report configuration from a network node having a plurality of antenna ports, wherein the report configuration comprises information regarding at least one adaptation pattern associated with a measurement resource configuration, and wherein the adaptation pattern indicates at least one of a target number of the antenna ports and a power offset value configured by the network node; and
transmitting, by the processor, a measurement report based on the report configuration.

2. The method of claim 1, wherein the adaptation pattern further indicates at least one of a subset selection of the antenna ports and a specified codebook configuration.

3. The method of claim 2, wherein the specified codebook configuration comprises an indication of at least one of a rank restriction, a number of antenna ports in a first dimension and a number of antenna ports in a second dimension, a codebook subset restriction for a single-panel codebook, a number of panels, a codebook subset restriction for a multi-panel codebook and a codebook subset restriction for two-transmission (two-TX).

4. The method of claim 1, wherein the power offset value is used to determine at least one candidate power offset value.

5. The method of claim 2, wherein the adaptation pattern comprises a list of sub-configurations, a sub-configuration corresponds to an antenna port subset, and wherein the method further comprises:
measuring, by the processor, a channel state information-reference signal (CSI-RS) based on the report configuration, wherein the antenna port subset indicates one or more enabled or disabled antenna ports; and
generating, by the processor, the measurement report according to a result of the measuring of the CSI-RS and the specified codebook configuration.

6. The method of claim 5, wherein the sub-configuration comprises a bitmap parameter, and wherein the target number of the antenna ports is indicated by the bitmap parameter.

7. The method of claim 1, wherein the adaptation pattern further indicates a resource identity.

8. The method of claim 1, wherein the adaptation pattern comprises a list of sub-configurations, and wherein each sub-configuration corresponds to a list of measurement resources.

9. A method, comprising:
configuring, by a processor of an apparatus, at least one adaptation pattern associated with a measurement resource configuration, wherein the adaptation pattern indicates at least one of a target number of a plurality of antenna ports and a power offset value; and
transmitting, by the processor, a report configuration comprising information regarding the adaptation pattern to a communication apparatus for channel state information (CSI) evaluation.

10. The method of claim 9, wherein the adaptation pattern further indicates at least one of a subset selection of the antenna ports and a specified codebook configuration.

11. The method of claim 10, wherein the specified codebook configuration comprises an indication of at least one of a rank restriction, a number of antenna ports in a first dimension and a number of antenna ports in a second dimension, a codebook subset restriction for a single-panel codebook, a number of panels, a codebook subset restriction for a multi-panel codebook and a codebook subset restriction for two-transmission (two-TX).

12. The method of claim 9, wherein the power offset value is used to determine at least one candidate power offset value.

13. The method of claim 9, wherein the adaptation pattern comprises a list of sub-configurations, a sub-configuration corresponds to an antenna port subset, and wherein the method further comprises:
determining, by the processor, an enabled or disabled status of the antenna ports for the antenna port subset; and
transmitting, by the processor, one or more CSI reference signals (CSI-RS) associated with the antenna port subset, wherein one or more disabled antenna ports in the antenna port subset are not involved in the transmitting of the associated CSI-RS.

14. The method of claim 13, wherein the sub-configuration comprises a bitmap parameter, and wherein the target number of the antenna ports is indicated by the bitmap parameter.

15. The method of claim 9, wherein the adaptation pattern further indicates a resource identity.

16. The method of claim 9, wherein the adaptation pattern comprises a list of sub-configurations, and wherein each sub-configuration corresponds to a list of measurement resources.

17. A method, comprising:
configuring, by a processor of an apparatus, a cell-wise indication of an adaptation, wherein the cell-wise indication comprises information regarding at least one of a number of antenna ports enabled for channel state information (CSI) evaluation, a change in a power offset value and a reset of a predetermined procedure; and
transmitting, by the processor, the cell-wise indication to one or more communication apparatuses in a communication network.

18. The method of claim 17, wherein the predetermined procedure comprises at least one of a CSI evaluation procedure and a beam management procedure, and wherein the adaptation comprises at least one of a spatial domain adaptation and a power domain adaptation.

19. The apparatus of claim 17, wherein the cell-wise indication is transmitted via a group-specific downlink control information (DCI) or by a paging DCI.

20. The apparatus of claim 17, wherein the power offset value comprises at least one of a power offset for a physical downlink shared channel (PDSCH) relative to a CSI reference signal (CSI-RS) and a power offset for a CSI-RS relative to a secondary synchronization signal (SSS).
